(19) United States
(12) Patent Application Publication
(10) Pub. No.: US 2009/0161257 A1
(43) Pub. Date: Jun. 25, 2009

(54) MAGNETIC RECORDING MEDIUM, METHOD OF MANUFACTURING THE SAME, AND MAGNETIC RECORDING APPARATUS

(75) Inventors: Akiko Yuzawa, Yokohama-shi (JP); Masatoshi Sakurai, Tokyo (JP); Yoshiyuki Kamata, Tokyo (JP); Satoshi Shirotori, Yokohama-shi (JP); Kaori Kimura, Yokohama-shi (JP); Tsuyoshi Onitsuka, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/400,341

(22) Filed: Mar. 9, 2009

Related U.S. Application Data
(63) Continuation of application No. PCT/JP2008/061681, filed on Jun. 20, 2008.

(30) Foreign Application Priority Data
Jun. 28, 2007 (JP) 2007-171077

(51) Int. Cl. G11B 5/60; G11B 5/33; B44C 1/22

(52) U.S. Cl. 360/235.4; 428/800; 216/22; G9B/5.229

(57) ABSTRACT

According to one embodiment, a magnetic recording medium includes protruded magnetic patterns formed on a substrate, and a non-magnetic material filled in recesses between the magnetic patterns and made of a multi-element amorphous alloy containing Ni or Cu, and two or more metals selected from the group consisting of Ta, Nb, Ti, Zr, Hf, Cr, Mo and Ag.

### CROSS-REFERENCE TO RELATED APPLICATIONS

This is a Continuation Application of PCT Application No. PCT/JP2008/061681, filed Jun. 20, 2008, which was published under PCT Article 21(2) in English.

This application is based upon and claims the benefit of priority from Japanese Patent Application No. 2007-171077, filed Jun. 28, 2007, the entire contents of which are incorporated herein by reference.

### BACKGROUND

1. Field

One embodiment of the present invention relates to a magnetic recording medium, a method of manufacturing the same, and a magnetic recording apparatus.

2. Description of the Related Art

Recently, in the magnetic recording medium incorporated into hard disk drives (HDDs), there is an increasing problem of disturbance of enhancement of track density due to interference between adjacent tracks. In particular, a serious technical subject is reduction of write blurring due to fringe effect of magnetic fields from a write head.

To solve such a problem, for example, a discrete track recording-type patterned medium (DTR medium) has been proposed in which recording tracks are physically separated. The DTR medium is capable of reducing a side erase phenomenon of erasing information of an adjacent track in writing or a side read phenomenon of reading out information of an adjacent track in reading, and is hence known to enhance the track density. Therefore, the DTR medium is expected as a magnetic recording medium capable of providing a high recording density.

To read and write a DTR medium with a flying head, it is desired to flatten the surface of the DTR medium. Specifically, in order to separate adjacent tracks completely, for example, a protective layer with a thickness of about 4 nm and a ferromagnetic layer with a thickness of about 20 nm are removed to form grooves of about 24 nm in depth, thereby forming magnetic patterns. On the other hand, since the designed flying height of the flying head is about 10 nm, head flying is made unstable if deep grooves are left remained. Accordingly, it has been attempted to fill the grooves between magnetic patterns with a non-magnetic material so as to flatten the medium surface for ensuring flying stability of the head.

Conventionally, the following method has been proposed to provide a DTR medium having a flat surface by filling the grooves between magnetic patterns with a non-magnetic material. For example, in a known method, by two-stage bias sputtering, the grooves between magnetic patterns are filled with a non-magnetic material to provide a DTR medium with a flat surface (see Japanese Patent No. 3,686,067).

However, as a result of studies by the present inventors, when the grooves between magnetic patterns are filled with a non-magnetic material by bias sputtering, the magnetic recording medium is deteriorated or affected due to temperature rise caused by substrate bias. It has been also found that bias sputtering generates dusts during the process which stick to the surface, leading to tendency to cause head crash.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a plan view of a DTR medium according to an embodiment of the invention along the circumferential direction;

FIGS. 2A to 2J are cross-sectional views showing a method of manufacturing the DTR medium according to the embodiment of the invention; and

FIG. 3 is a perspective view of a magnetic recording apparatus according to an embodiment of the invention.

### DETAILED DESCRIPTION

Various embodiments according to the invention will be described hereinafter with reference to the accompanying drawings. In general, according to one embodiment of the invention, there is provided a magnetic recording medium characterized by comprising: protruded magnetic patterns formed on a substrate; and a non-magnetic material filled in recesses between the magnetic patterns and made of a multi-element amorphous alloy containing Ni or Cu, and two or more metals selected from the group consisting of Ta, Nb, Ti, Zr, Hf, Cr, Mo and Ag. According to another embodiment of the present invention, there is provided a method of manufacturing a magnetic recording medium characterized by comprising: forming protruded magnetic patterns on a substrate; filling recesses between the magnetic patterns with a non-magnetic material made of a multi-element amorphous alloy containing Ni or Cu, and two or more metals selected from the group consisting of Ta, Nb, Ti, Zr, Hf, Cr, Mo and Ag; and etching back the non-magnetic material.

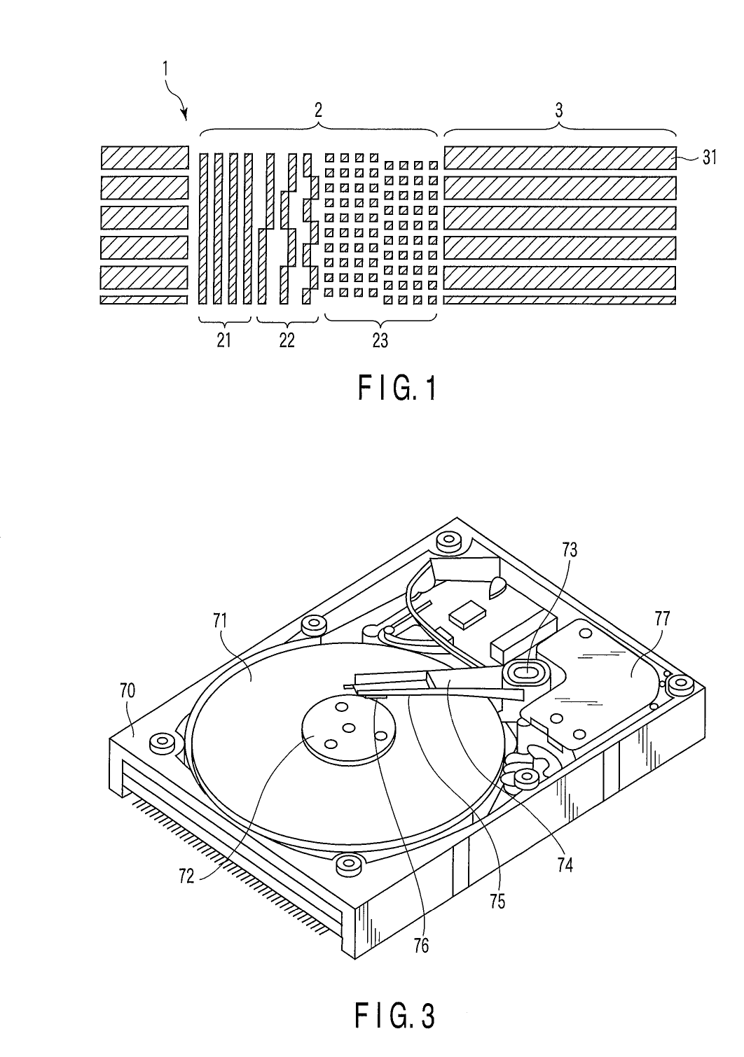

FIG. 1 is a plan view of a DTR medium according to an embodiment of the invention along the circumferential direction. As shown in FIG. 1, servo zones 2 and data zones 3 are alternately formed along the circumferential direction of the DTR medium 1. The servo zone 2 includes a preamble section 21, address section 22, and burst section 23. The data zone 3 includes discrete tracks 31.

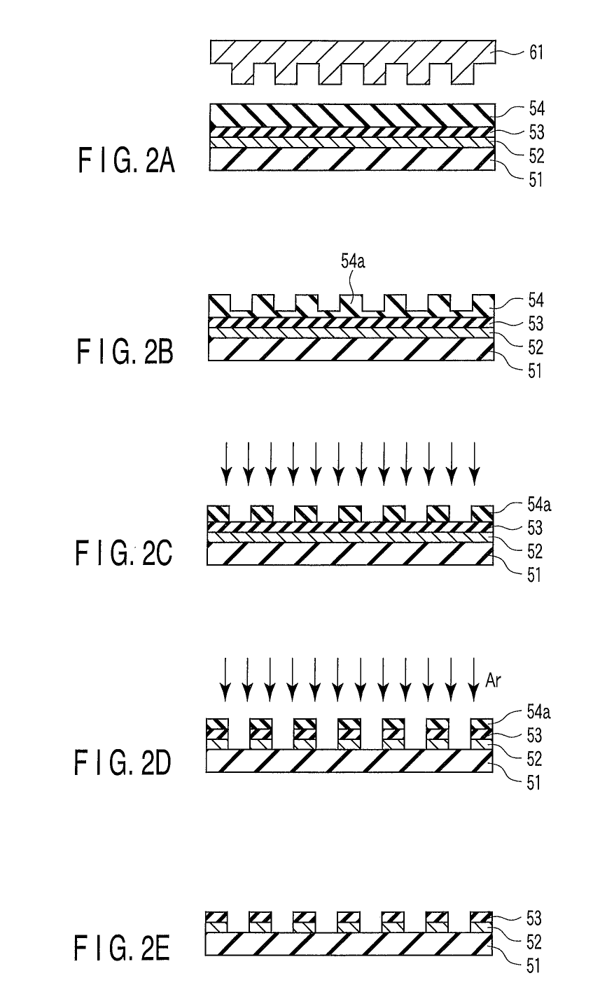

Referring now to FIGS. 2A to 2J, a method of manufacturing the DTR medium according to the embodiment of the invention will be described.

On a glass substrate 51, a soft magnetic underlayer made of CoZrNb with a thickness of 120 nm, an underlayer for orientation control made of Ru with a thickness of 20 nm, a ferromagnetic layer 52 made of CoCrPt—SiO₂ with a thickness of 20 nm, and a protective layer 53 made of carbon (C) with a thickness of 4 nm are successively formed. To simplify the illustration, the soft magnetic underlayer and the orientation control layer are not shown. On the protective layer 53, spin-on-glass (SOG) with a thickness of 100 nm is formed as a resist 54 by spin-coating. A stamper 61 is arranged to face the resist 54. The stamper 61 has patterns of protrusions and recesses in an inverted form of the magnetic patterns shown in FIG. 1 (see FIG. 2A).

Imprinting is performed by using the stamper 61 to form protrusions 54a of the resist 54 corresponding to the recesses in the stamper 61 (FIG. 2B).

Etching is performed with an ICP (inductively coupled plasma) etching apparatus to remove resist residues remaining on the bottoms of the recesses of the patterned resist 54. The conditions in the process are as follows: for instance, CF₄ is used as the process gas, the chamber pressure is set to 2 mTorr, the coil RF power and the platen RF power are set to 100 W, respectively, and the etching time is set to 30 seconds (FIG. 2C).

Using the resist patterns (SOG) left unremoved as etching masks, ion milling is performed with an ECR (electron cyclotron resonance) ion gun to etch the protective layer 53 with a thickness of 4 nm and the ferromagnetic layer 52 with a thickness of 20 nm (FIG. 2D). The conditions in the process are as follows: for instance, Ar is used as the process gas, the microwave power is set to 800 W, the acceleration voltage is set to 500 V and the etching time is set to 3 minutes.

Then, the resist patterns (SOG) are stripped off with a RIE apparatus (FIG. 2E). The conditions in the process are as follows: for instance, CF₄ gas is used as the process gas, the chamber pressure is set to 100 mTorr and the power is set to 400 W.

Next, without application of substrate bias, a multi-element amorphous alloy as a non-magnetic material 55 is deposited in a thickness of 50 nm so as to fill in the recesses between magnetic patterns by high-pressure sputtering (FIG. 2F). The conditions in the process are as follows: a sputtering apparatus for HDD is used, the Ar pressure is set to 1 to 10 Pa, for example, as high as 7 Pa, and the power is set to, for example, 500 W without application of substrate bias. The high-pressure sputtering makes it advantageous to fill the recesses with the non-magnetic material without defects because sputtered particles enter the grooves from various directions by which coverage on the groove sidewalls is improved.

The multi-element amorphous alloy constituting the non-magnetic material 55 is not particularly limited as long as it is a ternary or more amorphous alloy containing Ni or Cu and two or more metals selected from the group consisting of Ta, Nb, Ti, Zr, Hf, Cr, Mo and Ag, in which constituent elements are different in the atomic size by 12% or more. Such multi-element amorphous alloy is hardly crystallized even if it is subjected to temperature rise. Such multi-element amorphous alloy has excellent properties of filling into recesses and has a proper hardness. The hardness of the multi-element amorphous alloy is preferably to be 5.5 GPa or more to 20 GPa or less.

Specific examples of the multi-element amorphous alloys are represented by the following formulas:

Ni_{100-a-b-c-d}TaₐNb_{b}Ti_{c}Hf_{d},

where 0 at %≦a≦40 at %, 5 at %≦b≦40 at %,

0 at %≦c≦40 at %, and 0 at %<d<30 at %, and

Cu_{100-x-y}(Hf+Zr)ₓTi₂,

where 5 at %≦x≦60 at %, and

0 at %≦y≦50 at %.

More specific examples include Ni-based amorphous alloys such as Ni₆₀Nb₂₅Ti₁₅ and Ni₆₀Nb₂₀Ti_{12.5}Hf_{7.5}, and Cu-based amorphous alloys such as Cu₆₀Hf₁₅Zr₁₀Ti₁₅. Besides, NiNbCrMoP or the like may be used. The thickness of the multi-element amorphous alloy is preferably 30 nm to 100 nm. If the thickness of the multi-element amorphous alloy is too small, it is not preferred because the ferromagnetic layer may be damaged in the subsequent process. In the stage of FIG. 2F, the surface of the medium is not flat, but the pattern intervals are narrowed.

The non-magnetic material 55 of multi-element amorphous alloy is then etched back (FIG. 2G). The conditions in the process are as follows: an ECR ion gun is used, the Ar pressure is set to 3 to 4 Pa, the microwave power is set to 800 W, the acceleration voltage is set to 500 V, and Ar ions are applied for one minute. In these conditions, the non-magnetic material 55 is etched by about 10 nm. As a result, the depth of recesses of the non-magnetic material 55 is reduced, and the surface roughness is also decreased. This process is intended to modify the surface through etch-back of the non-magnetic material 55, and thus the conditions of the ECR ion gun such as the process time are not so important parameters. The longer the ion irradiation time, the greater the effects of decreasing the surface roughness and reducing the recess depth, but it is necessary to make the deposited non-magnetic material thicker in the filling process of the non-magnetic material 55 in FIG. 2F.

The process gas is not limited to Ar alone, but a mixed gas of Ar and oxygen may be used. When a mixed gas of Ar and oxygen is used, as compared with the case of using Ar alone, the effect of decreasing surface roughness is inferior, but the effect of reducing recess depth is improved.

Successively, without application of substrate bias, a multi-element amorphous alloy is deposited, as a non-magnetic material 56, again on the non-magnetic material 55 (FIG. 2H). As a result, the surface roughness of the non-magnetic material 56 is decreased substantially.

Further, ion milling is performed with an ECR ion gun to etch back the non-magnetic materials 56 and 55 (FIG. 2I). The conditions in the process are as follows: Ar is used as the process gas, the microwave power is set to 800 W, the acceleration voltage is set to 700 V and the etching time is 5 minutes. Using a quadrupole mass spectrometer (Q-MASS), the end point of the etch-back is determined when Co contained in the ferromagnetic layer is detected. In the method according to the embodiment of the invention, it cannot be judged accurately how much the non-magnetic material 55 is etched in the first etching-back process in FIG. 2G. Thus, if the etch-back is controlled on the basis of time in this process, the precision the end point of etch-back becomes inferior. Accordingly, by detecting the end point of etch-back using Q-MASS or other etching end point detector (for example, secondary ion mass spectrometer SIMS), highly precise etch-back can be attained.

Increasing the number of times of repetition of deposition and etch-back of the non-magnetic material makes it possible to flatten the surface and decrease the surface roughness.

Finally, carbon (C) is deposited by CVD (chemical vapor deposition) to form a protective layer 57 (FIG. 2J). Further, a lubricant is applied to the protective film 57 to provide a DTR medium.

Next, preferable materials to be used in the embodiments of the present invention will be described.

<Substrate>

As the substrate, for example, a glass substrate, Al-based alloy substrate, ceramic substrate, carbon substrate or Si single crystal substrate having an oxide surface may be used. As the glass substrate, amorphous glass or crystallized glass is used. Examples of the amorphous glass include common soda lime glass and aluminosilicate glass. Examples of the crystallized glass include lithium-based crystallized glass. Examples of the ceramic substrate include common aluminum oxide, aluminum nitride or a sintered body containing silicon nitride as a major component and fiber-reinforced materials of these materials. As the substrate, those having a NiP layer on the above metal substrates or nonmetal substrates formed by plating or sputtering may be used.

<Soft Magnetic Underlayer>

The soft magnetic underlayer (SUL) serves a part of such a function of a magnetic head as to pass a recording magnetic field from a single-pole head for magnetizing a perpendicular magnetic recording layer in a horizontal direction and to circulate the magnetic field to the side of the magnetic head, and applies a sharp and sufficient perpendicular magnetic field to the recording layer, thereby improving read/write efficiency. For the soft magnetic underlayer, a material containing Fe, Ni or Co may be used. Examples of such a material may include FeCo-based alloys such as FeCo and FeCoV, FeNi-based alloys such as FeNi, FeNiMo, FeNiCr and FeNiSi, FeAl-based alloys and FeSi-based alloys such as FeAl, FeAlSi, FeAlSiCr, FeAlSiTiRu and FeAlO, FeTa-based alloys such as FeTa, FeTaC and FeTaN and FeZr-based alloys such as FeZrN. Materials having a microcrystalline structure such as FeAlO, FeMgO, FeTaN and FeZrN containing Fe in an amount of 60 at % or more or a granular structure in which fine crystal grains are dispersed in a matrix may also be used. As other materials to be used for the soft magnetic underlayer, Co alloys containing Co and at least one of Zr, Hf, Nb, Ta, Ti and Y may also be used. Such a Co alloy preferably contains 80 at % or more of Co. In the case of such a Co alloy, an amorphous layer is easily formed when it is deposited by sputtering. Because the amorphous soft magnetic material is not provided with crystalline anisotropy, crystal defects and grain boundaries, it exhibits excellent soft magnetism and is capable of reducing medium noise. Preferable examples of the amorphous soft magnetic material may include CoZr-, CoZrNb- and CoZrTa-based alloys.

An underlayer may further be formed beneath the soft magnetic underlayer to improve the crystallinity of the soft magnetic underlayer or to improve the adhesion of the soft magnetic underlayer to the substrate. As the material of such an underlayer, Ti, Ta, W, Cr, Pt, alloys containing these metals or oxides or nitrides of these metals may be used. An intermediate layer made of a nonmagnetic material may be formed between the soft magnetic underlayer and the recording layer. The intermediate layer has two functions including the function to cut the exchange coupling interaction between the soft magnetic underlayer and the recording layer and the function to control the crystallinity of the recording layer. As the material for the intermediate layer Ru, Pt, Pd, W, Ti, Ta, Cr, Si, alloys containing these metals or oxides or nitrides of these metals may be used.

In order to prevent spike noise, the soft magnetic underlayer may be divided into plural layers and Ru layers with a thickness of 0.5 to 1.5 nm are interposed therebetween to attain anti-ferromagnetic coupling. Also, a soft magnetic layer may be exchange-coupled with a pinning layer of a hard magnetic film such as CoCrPt, SmCo or FePt having longitudinal anisotropy or an anti-ferromagnetic film such as IrMn and PtMn. A magnetic film (such as Co) and a nonmagnetic film (such as Pt) may be provided under and on the Ru layer to control exchange coupling force.

<Ferromagnetic Layer>

For the perpendicular magnetic recording layer, a material containing Co as a main component, at least Pt and further an oxide is preferably used. The perpendicular magnetic recording layer may contain Cr if needed. As the oxide, silicon oxide or titanium oxide is particularly preferable. The perpendicular magnetic recording layer preferably has a structure in which magnetic grains, i.e., crystal grains having magnetism, are dispersed in the layer. The magnetic grains preferably have a columnar structure which penetrates the perpendicular magnetic recording layer in the thickness direction. The formation of such a structure improves the orientation and crystallinity of the magnetic grains of the perpendicular magnetic recording layer, with the result that a signal-to-noise ratio (SN ratio) suitable to high-density recording can be provided. The amount of the oxide to be contained is important to provide such a structure.

The content of the oxide in the perpendicular magnetic recording layer is preferably 3 mol % or more and 12 mol % or less and more preferably 5 mol % or more and 10 mol % or less based on the total amount of Co, Cr and Pt. The reason why the content of the oxide in the perpendicular magnetic recording layer is preferably in the above range is that, when the perpendicular magnetic recording layer is formed, the oxide precipitates around the magnetic grains, and can separate fine magnetic grains. If the oxide content exceeds the above range, the oxide remains in the magnetic grains and damages the orientation and crystallinity of the magnetic grains. Moreover, the oxide precipitates on the upper and lower parts of the magnetic grains, with an undesirable result that the columnar structure, in which the magnetic grains penetrate the perpendicular magnetic recording layer in the thickness direction, is not formed. The oxide content less than the above range is undesirable because the fine magnetic grains are insufficiently separated, resulting in increased noise when information is reproduced, and therefore, a signal-to-noise ratio (SN ratio) suitable to high-density recording is not provided.

The content of Cr in the perpendicular magnetic recording layer is preferably 0 at % or more and 16 at % or less and more preferably 10 at % or more and 14 at % or less. The reason why the content of the Cr is preferably in the above range is that the uniaxial crystal magnetic anisotropic constant Ku of the magnetic grains is not too much reduced and high magnetization is retained, with the result that read/write characteristics suitable to high-density recording and sufficient thermal fluctuation characteristics are provided. The Cr content exceeding the above range is undesirable because Ku of the magnetic grains is lowered, and therefore, the thermal fluctuation characteristics are deteriorated, and also, the crystallinity and orientation of the magnetic grains are impaired, resulting in deterioration in read/write characteristics.

The content of Pt in the perpendicular magnetic recording layer is preferably 10 at % or more and 25 at % or less. The reason why the content of Pt is preferably in the above range is that the Ku value required for the perpendicular magnetic layer is provided, and further, the crystallinity and orientation of the magnetic grains are improved, with the result that the thermal fluctuation characteristics and read/write characteristics suitable to high-density recording are provided. The Pt content exceeding the above range is undesirable because a layer having an fcc structure is formed in the magnetic grains and there is a risk that the crystallinity and orientation are impaired. The Pt content less than the above range is undesirable because a Ku value satisfactory for the thermal fluctuation characteristics suitable to high-density recording is not provided.

The perpendicular magnetic recording layer may contain one or more types of elements selected from B, Ta, Mo, Cu, Nd, W, Nb, Sm, Tb, Ru and Re besides Co, Cr, Pt and the oxides. When the above elements are contained, formation of fine magnetic grains is promoted or the crystallinity and orientation can be improved and read/write characteristics and thermal fluctuation characteristics suitable to high-density recording can be provided. The total content of the above elements is preferably 8 at % or less. The content exceeding 8 at % is undesirable because phases other than the hcp phase are formed in the magnetic grains and the crystallinity and orientation of the magnetic grains are disturbed, with the result that read/write characteristics and thermal fluctuation characteristics suitable to high-density recording are not provided.

As the perpendicular magnetic recording layer, a CoPt-based alloy, CoCr-based alloy, CoPtCr-based alloy, CoPtO, CoPtCrO, CoPtSi, CoPtCrSi, a multilayer structure of an alloy layer containing at least one type selected from the group consisting of Pt, Pd, Rh and Ru and a Co layer, and materials obtained by adding Cr, B or O to these layers, for example, CoCr/PtCr, CoB/PdB and CoO/RhO may be used.

The thickness of the perpendicular magnetic recording layer is preferably 5 to 60 nm and more preferably 10 to 40 nm. When the thickness is in this range, a magnetic recording apparatus suitable to higher recording density can be manufactured. If the thickness of the perpendicular magnetic recording layer is less than 5 nm, read outputs are too low and noise components tend to be higher. If the thickness of the perpendicular magnetic recording layer exceeds 40 nm, read outputs are too high and the waveform tends to be distorted. The coercivity of the perpendicular magnetic recording layer is preferably 237000 A/m (3000 Oe) or more. If the coercivity is less than 237000 A/m (3000 Oe), thermal fluctuation resistance tends to be deteriorated. The perpendicular squareness of the perpendicular magnetic recording layer is preferably 0.8 or more. If the perpendicular squareness is less than 0.8, the thermal fluctuation resistance tends to be deteriorated.

<Protective Layer>

The protective layer is provided for the purpose of preventing corrosion of the perpendicular magnetic recording layer and also preventing the surface of a medium from being damaged when the magnetic head is brought into contact with the medium. Examples of the material of the protective layer include those containing C, SiO₂ or ZrO₂. The thickness of the protective layer is preferably 1 to 10 nm. This is preferable for high-density recording because the distance between the head and the medium can be reduced. Carbon may be classified into sp²-bonded carbon (graphite) and sp³-bonded carbon (diamond). Though sp³-bonded carbon is superior in durability and corrosion resistance to graphite, it is inferior in surface smoothness to graphite because it is crystalline material. Usually, carbon is deposited by sputtering using a graphite target. In this method, amorphous carbon in which sp²-bonded carbon and sp³-bonded carbon are mixed is formed. Carbon in which the ratio of sp³-bonded carbon is larger is called diamond-like carbon (DLC). DLC is superior in durability and corrosion resistance and also in surface smoothness because it is amorphous and therefore utilized as the surface protective layer for magnetic recording media. The deposition of DLC by CVD (chemical vapor deposition) produces DLC through excitation and decomposition of raw gas in plasma and chemical reactions, and therefore, DLC richer in sp³-bonded carbon can be formed by adjusting the conditions.

Next, preferred manufacturing conditions in each process in the embodiments of the present invention will be described.

<Imprinting>

A resist is applied to the surface of a substrate by spin-coating and then, a stamper is pressed against the resist to thereby transfer the patterns of the stamper to the resist. As the resist, for example, a general novolak-type photoresist or spin-on-glass (SOG) may be used. The surface of the stamper on which patterns of protrusions and recesses corresponding to servo information and recording tracks are formed is made to face the resist on the substrate. In this process, the stamper, the substrate and a buffer layer are placed on the lower plate of a die set and are sandwiched between the lower plate and the upper plate of the die set to be pressed under a pressure of 2000 bar for 60 seconds, for example. The height of the protrusions of the patterns formed on the resist by imprinting is, for instance, 60 to 70 nm. The above conditions are kept for about 60 seconds for transporting the resist to be excluded. In this case, if a fluorine-containing peeling agent is applied to the stamper, the stamper can be peeled from the resist satisfactorily.

<Removal of Resist Residues>

Resist residues left unremoved on the bottoms of the recesses of the resist are removed by RIE (reactive ion etching). In this process, an appropriate process gas corresponding to the material of the resist is used. As the plasma source, ICP (inductively coupled plasma) apparatus capable of producing high-density plasma under a low pressure is preferable, but an ECR (electron cyclotron resonance) plasma or general parallel-plate RIE apparatus may be used.

<Etching of Ferromagnetic Layer>

After the resist residues are removed, the ferromagnetic layer is processed using the resist patterns as etching masks. For the processing of the ferromagnetic layer, etching using Ar ion beams (Ar ion milling) is preferable. The processing may be carried out by RIE using Cl gas or a mixture gas of CO and NH₃. In the case of RIE using the mixture gas of CO and NH₃, a hard mask made of Ti, Ta or W is used as an etching mask. When RIE is used, a taper is scarcely formed on the side walls of the protruded magnetic patterns. In processing the ferromagnetic layer by Ar ion milling capable of etching any material, if etching is carried out under the conditions that, for example, the acceleration voltage is set to 400 V and incident angle of ions is varied between 30° and 70°, a taper is scarcely formed on the side walls of the protruded magnetic patterns. In milling using an ECR ion gun, if etching is carried out under static opposition arrangement (incident angle of ions is 90°), a taper is scarcely formed on the side walls of the protruded magnetic patterns.

<Stripping of Resist>

After the ferromagnetic layer is etched, the resist is stripped off. When a general photoresist is used as the resist, it can be easily stripped off by oxygen plasma treatment. Specifically, the photoresist is stripped off by using an oxygen ashing apparatus under the conditions that the chamber pressure is 1 Torr, power is 400 W and processing time is 5 minutes. When SOG is used as the resist, SOG is stripped off by RIE using fluorine-containing gas. As the fluorine-containing gas, CF₄ or SF₆ is suitable. Note that, it is preferable to carry out rinsing with water because the fluorine-containing gas reacts with moisture in the atmosphere to produce an acid such as HF and H₂SO₄.

<Etch-Back of Nonmagnetic Material>

Etch-back of the nonmagnetic material is carried out until the ferromagnetic film (or the carbon protective film on the ferromagnetic film) is exposed. This etch-back process is preferably carried out by Ar ion milling or etching with an ECR ion gun.

<Deposition of Protective Layer and Aftertreatment>

After etch-back, a carbon protective layer is deposited. The carbon protective layer may be deposited by CVD, sputtering or vacuum evaporation. CVD produces a DLC film containing a large amount of sp³-bonded carbon. The carbon protective layer with a thickness less than 2 nm is not preferable because it results in unsatisfactory coverage. Whereas, a carbon protective layer with a thickness exceeding 10 nm is not preferable because it increases magnetic spacing between a read/write head and a medium, leading to a reduction in SNR. A lubricant is applied to the surface of the protective layer. As the lubricant, for example, perfluoropolyether, fluorinated alcohol, fluorinated carboxylic acid or the like is used.

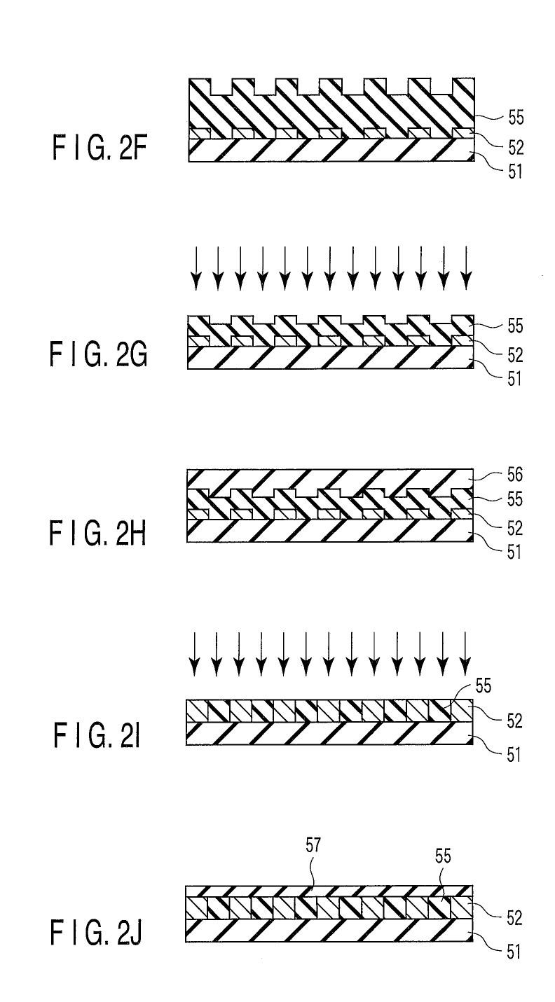

FIG. 3 is a perspective view of a magnetic recording apparatus (hard disk drive) according to an embodiment of the present invention. This magnetic recording apparatus includes, inside the chassis 70, the aforementioned magnetic recording medium (DTR medium) 71, a spindle motor 72 for rotating the magnetic recording medium 71, a head slider 76 having a magnetic head installed therein, a head suspension assembly including a suspension 75 supporting the head slider 76 and an actuator arm 74, and a voice coil motor (VCM) 77 as an actuator for the head suspension assembly.

The magnetic recording medium 71 is rotated by the spindle motor 72. A magnetic head including a write head and a read head is integrated with the head slider 76. The actuator arm 74 is rotatably mounted to a pivot 73. The suspension 75 is attached to one end of the actuator arm 74. The head slider 76 is elastically supported via a gimbal provided on the suspension 75. The voice coil motor (VCM) 77 is disposed on the other end of the actuator arm 74. The voice coil motor (VCM) 77 generates a rotating torque for the actuator arm 74 around the pivot 73, and positions the magnetic head in a flying state over an arbitrary radial position of the magnetic recording medium 71.

### EXAMPLES

### Example 1

Using a stamper having patterns of protrusions and recesses of servo patterns (preamble, address, burst) and recording tracks formed thereon as shown in FIG. 1, a DTR medium was manufactured in the method shown in FIGS. 2A to 2J. Specifically, in the filling process of a non-magnetic material 55 (FIG. 2F), a film of Ni₆₀Nb₂₅Ti₁₅ as a multi-element amorphous alloy was deposited in a thickness of 50 nm at a high pressure (7.0 Pa). In the etch-back process (FIG. 2G), using an ECR ion gun, Ar ions were applied for one minute at microwave power of 800 W and acceleration voltage of 500 V. These processes were repeated five times.

At this stage, the surface of the medium was measured with an atomic force microscope (AFM). As a result, Ra was 1.478 nm, showing a smooth surface. It was confirmed that the track pitch was 190 nm and the depth of recesses was about 5 nm, and the surface was successfully flattened.

Thus, by using a multi-element amorphous alloy as the non-magnetic material, a favorable flatness is provided by repetition of about five times, and the number of repetitions of processes can be decreased.

### Comparative Example 1

A DTR medium was manufactured in the same manner as in example 1 except that Ni₅₀Al₅₀ was used as the non-magnetic material.

When the surface of the medium was measured with AFM, Ra was 2.42 nm, showing a rough surface. In a portion where an interval of address pattern was wide, the depth of recesses was as large as 15 nm. Particles like crystal grains were observed on the surface. It is found that, if a crystalline alloy material is used as the non-magnetic material, etching of the crystalline alloy is influenced by the crystal orientation, which is not suited to surface flattening.

### Example 2

A DTR medium was manufactured in the same manner as in example 1 except that the filling process and etch-back process of the non-magnetic material were repeated 96 times. That is, in the filling process of a non-magnetic material 55 (FIG. 2F), a film of Ni₆₀Nb₂₅Ti₁₅ was deposited in a thickness of 50 nm at a high pressure (7.0 Pa). In the etching-back process (FIG. 2G), using an ECR ion gun, Ar ions were applied for one minute at microwave power of 800 W and acceleration voltage of 500 V. These processes were repeated 96 times.

At this stage, the surface of the medium was measured with AFM. As a result, it was confirmed that a very smooth surface was formed. In the glide test, noise was observed, but signal peaks due to irregularity were not observed. The head flying height was measured with a laser Doppler vibrometer (LDV). As a result, no drop of the head was observed. If there is a recess of 10 nm in depth on the surface, the head drop is about 1.0 nm. Considering this fact, since there is no head drop, the surface is supposed to be very smooth. The number of repetitions necessary for filling of the non-magnetic material depends on the pattern pitch, and when the pitch is smaller, the number of repetitions can be decreased.

### Example 3

Using a stamper having patterns of protrusions and recesses of servo patterns (preamble, address, burst) and recording tracks formed thereon as shown in FIG. 1, a DTR medium was manufactured in the method shown in FIGS. 2A to 2J. Specifically, in the filling process of a non-magnetic material 55 (FIG. 2F), a film of NiNbTiHf as a multi-element amorphous alloy was deposited in a thickness of 50 nm at a high pressure (7.0 Pa). In the etch-back process (FIG. 2G), using an ECR ion gun, Ar ions were applied for one minute at microwave power of 800 W and acceleration voltage of 500 V. These processes were repeated plural times.

At this stage, the surface of the medium was measured with an atomic force microscope (AFM), and Ra was found to be small as in example 1.

The non-magnetic material for filling the recesses between magnetic patterns is preferred to be a multi-element amorphous alloy containing Ni or Cu, and two or more metals selected from the group consisting of Ta, Nb, Ti, Zr, Hf, Cr, Mo and Ag.

The hardnesses of various multi-element amorphous alloys were measured with a nano-indenter. The results were as follows.

Ni₆₀Nb₂₅Ti₁₅: 8.5 GPa,

Ni₆₀Nb₂₀Ti₁₂Hf₈: 8.3 GPa,

Ni₆₀Nb₂₀Ti₁₅Hf₅: 8.1 GPa,

Cu₆₀Hf₁₅Zr₁₀Ti₁₅: 7.8 GPa.

### Comparative Example 2

A DTR medium was manufactured in the same manner as in example 1 except that SiO₂ was used as the non-magnetic material.

When the resultant DTR medium was evaluated using the flying head, a head crash occurred in several minutes, and the DTR medium was damaged. The hardness of SiO₂ measured with a nano-indenter was as low as 5.5 GPa.

Further, a DTR medium was manufactured in the same manner as in example 1 except that carbon of higher harness (hardness: 20 GPa) was used as the non-magnetic material.

When the resultant DTR medium was evaluated using the flying head, the head drop was 0.8 nm and head flying was unstable. This shows a poor filling property of carbon used as the non-magnetic material. When carbon is used as the non-magnetic material, the number of repetitions from several tens to hundreds of processes should be required for sufficiently flattening the surface.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording medium comprising:
protruded magnetic patterns formed on a substrate; and
a non-magnetic material filled in recesses between the magnetic patterns and made of a multi-element amorphous alloy containing Ni or Cu, and two or more metals selected from the group consisting of Ta, Nb, Ti, Zr, Hf, Cr, Mo and Ag.

2. The magnetic recording medium of claim 1, wherein the multi-element amorphous alloy has hardness of 5.5 GPa or more to 20 GPa or less.

3. The magnetic recording medium of claim 1, wherein the multi-element amorphous alloy is represented by the following formula:
Ni_{100-a-b-c-d}TaₐNb_{b}Ti_{c}Hf_{d},
where 0 at %≦a≦40 at %, 5 at %≦b≦40 at %, 0 at %≦c≦40 at %, and 0 at %<d<30 at %, or
Cu_{100-x-y}(Hf+Zr)ₓTi₂,
where 5 at %≦x≦60 at %, and 0 at %≦y≦50 at %.

4. A method of manufacturing a magnetic recording medium, comprising:
forming protruded magnetic patterns on a substrate;
filling recesses between the magnetic patterns with a non-magnetic material made of a multi-element amorphous alloy containing Ni or Cu, and two or more metals selected from the group consisting of Ta, Nb, Ti, Zr, Hf, Cr, Mo and Ag; and
etching back the non-magnetic material.

5. The method of claim 4, wherein filling with the non-magnetic material and etching-back of the non-magnetic material are repeated.

6. A magnetic recording apparatus comprising:
the magnetic recording medium of claim 1;
a spindle motor which rotates the magnetic recording medium;
an actuator;
an actuator arm driven by the actuator; and
a head slider provided with a read/write head and supported by the actuator arm in a state of flying over the magnetic recording medium.
